(19) United States
(12) Patent Application Publication
(10) Pub. No.: US 2007/0045452 A1
(43) Pub. Date: Mar. 1, 2007

(54) Slip-on misting elements and method

(76) Inventor: Thomas A. Bontems, Mesa, AZ (US)

Correspondence Address: ROBERT A. PARSONS, 4000 N. CENTRAL AVENUE, SUITE 1220, PHOENIX, AZ, 85012, US

(21) Appl. No.: 11/216,982

(22) Filed: Aug. 31, 2005

(51) Int. Cl. A24F 25/00; B05B 15/00

(52) U.S. Cl. 239/547; 239/34

(57) ABSTRACT

A misting system includes a continuous conduit and a plurality of misting elements. Each element includes a tubular body designed to receive the continuous conduit therethrough, a compression member affixed to the body and movable between a body positioning mode in which the body is movable along the conduit and a body fixing mode in which the body is fixedly positioned on the conduit, a radially extending opening through the tubular body, and a nozzle positioned in the radially extending opening. Each of the plurality of elements is positioned in spaced apart relationship on the continuous conduit with the compression member of each element in the body fixing mode. Holes are formed in the conduit in each of the radially extending opens through the tubular bodies and the nozzle of each element is positioned in the radially extending opening and in communication with the hole in the conduit.

### FIELD OF THE INVENTION

This invention relates in general to misting systems and to methods of fabricating or assembling misting systems.

### BACKGROUND OF THE INVENTION

At the present time, misting systems are used in many homes, businesses and other areas where people congregate in outside areas. For example, it is common to install misting systems in home patios or garden areas, outdoor restaurant areas, or any areas where outside activities take place. The misting systems generally consist of spaced apart misting elements that direct a fine mist, generally developed under relatively high water pressure, into the desired area so that as the mist evaporates it cools the area.

Several problems are predominant in prior art misting systems. A major problem is the proper placing of the misting elements around the chosen area to get the maximum benefit. In all known prior art misting systems a conduit carries water to an inlet and from an outlet of each misting element. The inlet of the element is affixed to an end of a first piece of conduit and a second piece of conduit is affixed to the outlet of the element. This requires precise measuring and cutting of the pieces of conduit to properly place multiple misting elements around a chosen area. Further, during assembly pieces of conduit can break or come loose from an element resulting in leakage and extensive and difficult repairs. Also, in most prior art misting systems higher pressure water sources are required to obtain the desired misting. This generally means an additional pump or water pressure source.

It would be highly advantageous, therefore, to remedy the foregoing and other deficiencies inherent in the prior art.

Accordingly, it is an object of the present invention to provide a new and improved misting system with improved misting elements.

Another object of the invention is to provide a new and improved misting system that is easily installed and the novel method of installation.

Another object of the invention is to provide a new and improved misting system that is relatively inexpensive to install and operate.

### SUMMARY ON THE INVENTION

Briefly, to achieve the desired objects of the instant invention in accordance with a preferred embodiment thereof, provided is a misting element for a misting system. The misting element includes a tubular body designed to receive a conduit therethrough, a compression member affixed to the body and movable between a body positioning mode in which the body is movable along the conduit and a body fixing mode in which the body is fixedly positioned on the conduit, a radially extending opening through the tubular body, and a nozzle positioned in the radially extending opening.

The desired objects and purposes of the present invention are further realized in a misting system including a plurality of the above described misting nozzles positioned in spaced apart relationship on a continuous conduit.

The desired objects and purposes of the present invention are further realized in a method of installing a misting element on a continuous conduit including the following steps: providing a continuous conduit; providing a misting element including a tubular body designed to receive the conduit therethrough, a compression member affixed to the body and movable between a body positioning mode in which the body is movable along the conduit and a body fixing mode in which the body is fixedly positioned on the conduit, a radially extending opening through the tubular body, and a nozzle engagable in the radially extending opening; sliding the tubular body on to the conduit, with the compression member in the body positioning mode, and positioning the body at a selected position along the conduit; moving the compression member into the body fixing mode to fixedly position the misting element on the conduit at the selected position; forming a hole in the conduit within the radially extending opening through the tubular body; and engaging the misting nozzle in the radially extending opening through the tubular body and in communication with the hole in the conduit.

### BRIEF DESCRIPTION OF THE DRAWING

The foregoing and further and more specific objects and advantages of the instant invention will become readily apparent to those skilled in the art from the following detailed description taken in conjunction with the drawings in which:

FIG. 1 is a perspective view of a misting system installed on a roof in accordance with the present invention;

FIG. 2 is a partially exploded view in perspective of a misting element in accordance with the present invention;

FIG. 3 is a sectional exploded view of the misting element of FIG. 2;

FIG. 4 is a sectional view of the element of FIG. 2 installed on a conduit;

FIG. 5 is a perspective view of a compression member of the misting element of FIG. 2; and

FIG. 6 is a partially exploded view in perspective of the misting element of FIG. 2 illustrating installation steps.

### DETAILED DESCRIPTION OF THE DRAWINGS

Turning now to the drawings, attention is first directed to FIG. 1 which illustrates a misting system 10 in accordance with the present invention. Misting system 10 is installed along the edge of a roof 12, used in this example only for illustrative purposes. Misting system 10 includes a conduit 14 extending along a chosen misting path and a plurality of misting elements 16 spaced along conduit 14, as will be explained in more detail presently.

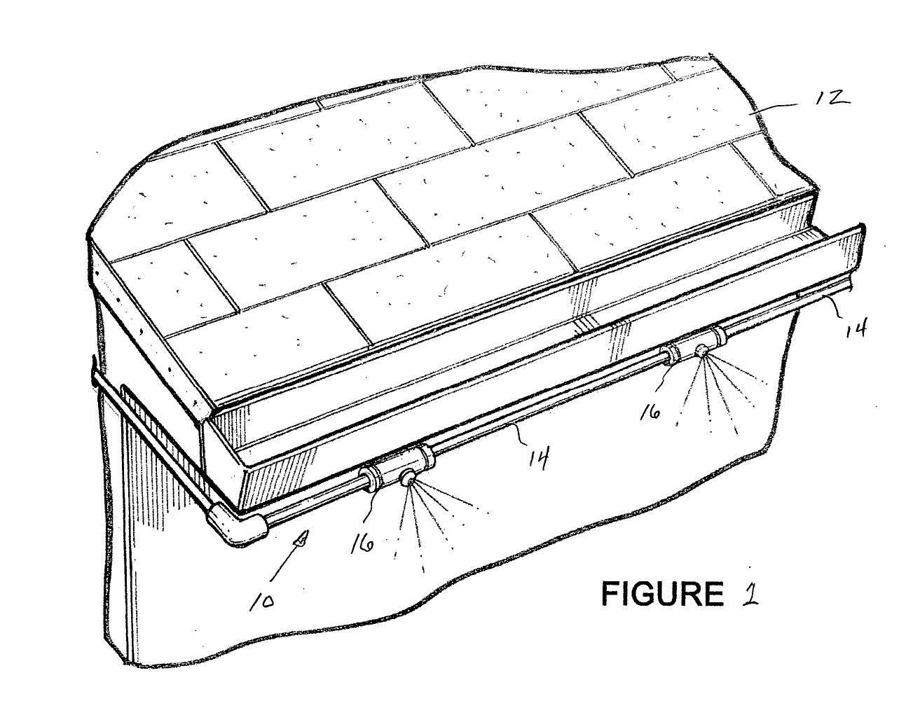

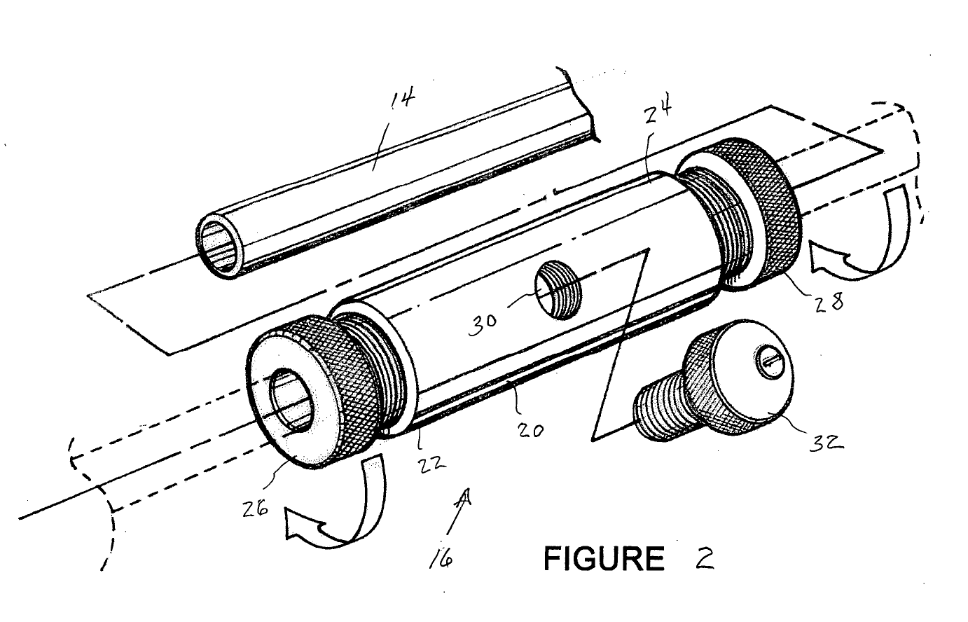

Turning now to FIG. 2 for a more detailed description of a single misting element 16, it can be seen that element 16 includes an elongated tubular body 20 which has internal threads in opposite ends 22 and 24 thereof. Compression members 26 and 28 are threadedly engaged in ends 22 and 24, respectively. Body 20 has an internally threaded opening 30 formed intermediate ends 22 and 24 and extending radially inwardly into communication with the internal longitudinally extending opening through body 20. A nozzle 32 is designed to be threadedly engaged in opening 30.

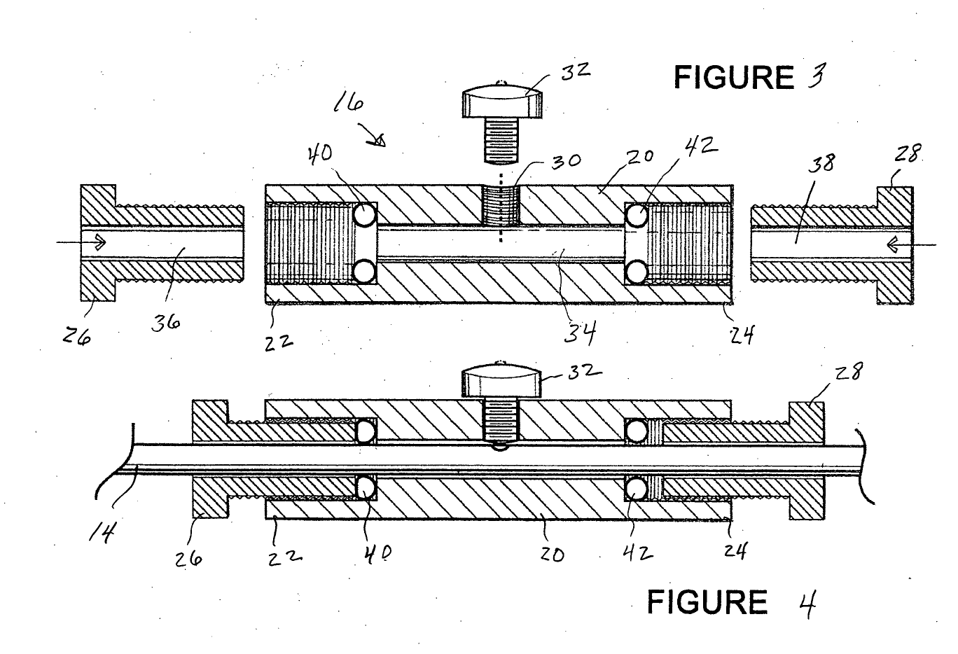

Referring additionally to FIGS. 3, 4, and 5, it can be seen that body 20 has a longitudinally extending opening 34 therethrough. Further, opening 34 is diametrically enlarged adjacent ends 22 and 24 to accommodate compression members 26 and 28. Also, each compression member 26 and 28 has a longitudinally extending opening 36 and 38, respectively, therethrough axially aligned with opening 34 through body 20 when compression members 26 and 28 are threadedly engaged in ends 22 and 24. As can best be seen in FIG. 4, longitudinally extending opening 34 through tubular body 20 and opening 36 and 38 through compression members 26 and 28 are designed to receive conduit 14 therethrough.

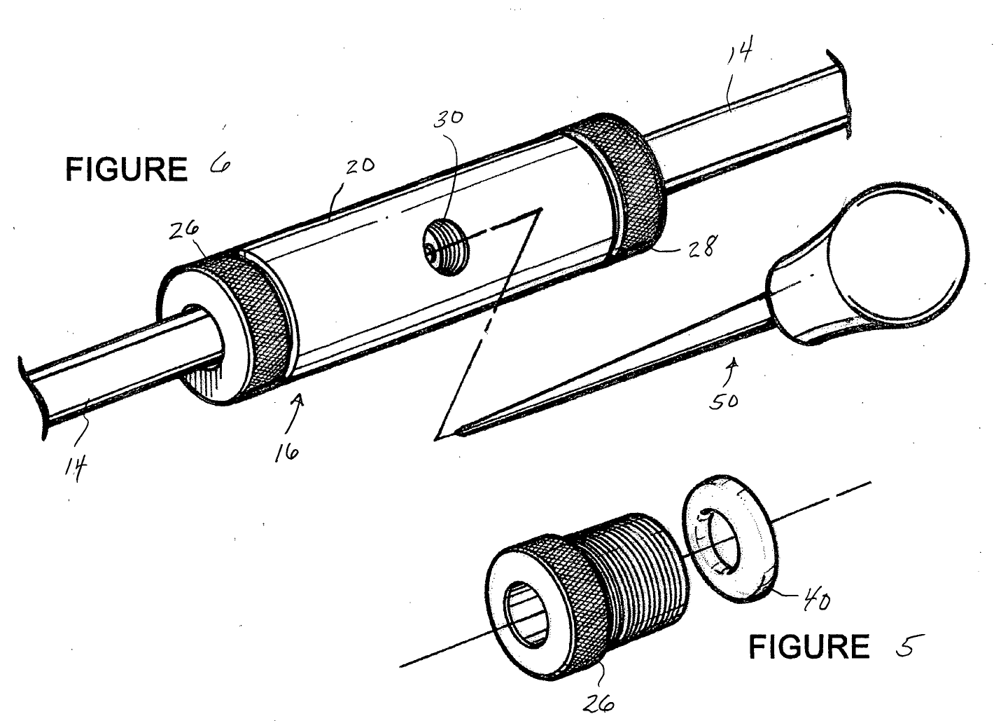

It will be understood that conduit 14 can be formed of any convenient material, such as copper tubing, plastic tubing, etc. and can be of any normal diameter. Further, the outer diameter of tubing 14 is preferably only slightly smaller than the inner diameter of longitudinally extending opening 34 through body 20 so that conduit 14 can be easily slipped through body 20 and compression members 26 and 28. In this embodiment, each compression member 26 and 28 has an O-ring 40 and 42, respectively, associated therewith, as can be seen in FIG. 5. Each compression member 26 and 28 is movable between a body positioning mode (e.g. compression member 28 in FIG. 4) in which the body is movable along the conduit and a body fixing mode (e.g. compression member 26 in FIG. 4) in which the body is fixedly positioned on the conduit, as explained in more detail below. Further, while two compression members are used in this embodiment it will be understood that a single compression member might be adequate in specific applications. It will be understood that a compression member at each end of elongated body 20 prevents any leaking of water through either end.

As can best be seen in FIG. 4, with conduit 14 extending through compression member 26, body 20 and compression member 28, tightening compression members 26 and/or 28 into body 20 compresses O-rings 40 and/or 42 to tightly grip conduit 14 and hold misting element 16 fixedly in place on conduit 14. In this embodiment the outer surface of compression members 26 and 28 are knurled to provide for good finger tightening but the outer surface might be formed to provide wrench (or other tool) tightening if desired. While O-rings 40 and 42 are used in this example to provide a gripping force on conduit 14, it will be understood that a wide variety of devices might be used and the O-rings are illustrated for exemplary purposes only.

Referring to FIG. 6, some steps in a process of installing the present misting system are illustrated. As can be determined from FIG. 6 and from the previous description, conduit 14 is conveniently positioned around the area to be misted. A plurality of misting elements 16 are slipped onto conduit 14 and can easily be slid along the outer surface to a position determined to be a desired misting position. Because conduit 14 does not have to be cut or measured, misting elements 16 can be easily dispersed about the selected misting area.

Once a position for a misting element 16 has been selected, compression members 26 and 28 are tightened into body 20 to compress O-rings 40 and 42 and hold compression element 16 fixedly at the selected position along conduit 14. In this way a plurality of misting elements can be easily spaced or distributed around a selected misting area. With misting element 16 fixedly held in the selected position, a tool 50, which may be an awl, a drill, or other hole making device, is inserted into opening 30 in body 20 and a hole is made in conduit 14. Nozzle 32 is then threadedly engaged in opening 30, as best illustrated in FIG. 4. Thus, nozzle 32 is in liquid communication with the hole in conduit 14 and receives water thereform.

With all of the misting elements 16 fixedly positioned on conduit 14 and in liquid communication therewith, one end of conduit 14 is attached to a pressurized source of water. Here it will be understood that one end of conduit 14 can be provided with a simple connection to a domestic water faucet, for example. Depending upon the number of misting elements distributed about a selected area and the size of the area, the present misting system can generally be accommodated by a normal domestic water source and additional pressure sources are usually not required.

Various changes and modifications to the embodiment herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A misting element for a misting system, the misting element comprising:
a tubular body designed to receive a conduit therethrough;
a compression member affixed to the body and movable between a body positioning mode in which the body is movable along the conduit and a body fixing mode in which the body is fixedly positioned on the conduit;
a radially extending opening through the tubular body; and
a nozzle positioned in the radially extending opening.

2. A misting element as claimed in claim 1 including a continuous conduit and a plurality of misting elements with the continuous conduit extending through each of the plurality of misting elements.

3. A misting element as claimed in claim 2 wherein the plurality of misting elements are fixed at spaced positions along the conduit by the compression member of each misting element in the body fixing mode.

4. A misting element as claimed in claim 3 wherein the radially extending opening through the tubular body is aligned with an opening in the conduit in each of the plurality of misting elements.

5. A misting element as claimed in claim 1 wherein the misting element includes an elongated body with threaded openings at opposed ends, and a pair of compression members, one each in each of the threaded openings.

6. A misting element as claimed in claim 5 wherein the compression members each have a longitudinally extending opening therethrough designed to coaxially receive the conduit therethrough.

7. A misting element as claimed in claim 6 wherein the tubular body includes a longitudinally extending opening with a diameter slightly larger than the conduit, the longitudinally extending openings through the compression members have a diameter approximately equal to the diameter of the longitudinally extending opening through the tubular body, and the longitudinally extending openings through the compression members and the longitudinally extending opening through the tubular body are all axially aligned to receive the conduit therethrough.

8. A misting element as claimed in claim 6 wherein the compression members each further include a flexible member designed to extend around the conduit in the threaded opening and to grip the conduit with the compression member in the body fixing mode.

9. A misting element as claimed in claim 1 wherein the radially extending opening through the tubular body is internally threaded, the nozzle is externally threaded, and the nozzle is threadedly engaged in the radially extending opening.

10. A misting system comprising:
a continuous conduit;
a plurality of misting elements each including a tubular body designed to receive the continuous conduit therethrough, a compression member affixed to the body and movable between a body positioning mode in which the body is movable along the conduit and a body fixing mode in which the body is fixedly positioned on the conduit, a radially extending opening through the tubular body, and a nozzle positioned in the radially extending opening;
each of the plurality of misting elements positioned in spaced apart relationship on the continuous conduit with the compression member of each misting element in the body fixing mode;
a plurality of holes formed in the conduit, one each in association with each of the misting elements and in substantially axial alignment with the radially extending opening through the tubular body; and
each of the plurality of misting elements having the nozzle positioned in the radially extending opening through the tubular body and in communication with the hole in the conduit.

11. A misting system as claimed in claim 10 wherein each misting element of the plurality of misting elements includes an elongated body with threaded openings at opposed ends, and a pair of compression members, one each in each of the threaded openings.

12. A misting system as claimed in claim 11 wherein the compression members each have a longitudinally extending opening therethrough designed to coaxially receive the conduit therethrough.

13. A misting system as claimed in claim 11 wherein the tubular body includes a longitudinally extending opening with a diameter slightly larger than the conduit, the longitudinally extending openings through the compression members have a diameter approximately equal to the diameter of the longitudinally extending opening through the tubular body, and the longitudinally extending openings through the compression members and the longitudinally extending opening through the tubular body are all axially aligned to receive the conduit therethrough.

14. A misting system as claimed in claim 11 wherein the compression members each further include a flexible member designed to extend around the conduit in the threaded opening and to grip the conduit with the compression member in the body fixing mode.

15. A misting system as claimed in claim 10 wherein the radially extending opening through the tubular body is internally threaded, the nozzle is externally threaded, and the nozzle is threadedly engaged in the radially extending opening.

16. A method of installing a misting element on a continuous conduit comprising the steps of:
providing a continuous conduit;
providing a misting element including a tubular body designed to receive the conduit therethrough, a compression member affixed to the body and movable between a body positioning mode in which the body is movable along the conduit and a body fixing mode in which the body is fixedly positioned on the conduit, a radially extending opening through the tubular body, and a nozzle engagable in the radially extending opening;
sliding the tubular body on to the conduit, with the compression member in the body positioning mode, and positioning the body at a selected position along the conduit;
moving the compression member into the body fixing mode to fixedly position the misting element on the conduit at the selected position;
forming a hole in the conduit within the radially extending opening through the tubular body; and
engaging the misting nozzle in the radially extending opening through the tubular body and in communication with the hole in the conduit.

17. A method as claimed in claim 16 including the steps of providing a plurality of similar misting elements, sliding the plurality of similar misting elements on to the continuous conduit and selecting spaced apart positions on the continuous conduit for each of the plurality of misting elements, moving the compression member of each of the plurality of similar misting elements into the body fixing mode to fixedly position each of the plurality of similar misting elements on the conduit at the selected position, forming a hole in the conduit within the radially extending opening through the tubular body for each of the plurality of similar misting elements, and engaging the misting nozzle in the radially extending opening through the tubular body and in communication with the hole in the conduit for each of the plurality of similar misting elements.
